(19) United States
(12) Patent Application Publication
(10) Pub. No.: US 2004/0045539 A1
(43) Pub. Date: Mar. 11, 2004

(54) Gaseous fuel supply apparatus and with shut-off valve

(75) Inventors: Yoshio Furuta, Kazo-si (JP); Masanori Yamashita, Kazo-si (JP); Keiji Akashi, Kazo-si (JP); Susumu Oneyama, Kazo-si (JP); Shou To, Kazo-si (JP)

Correspondence Address: Cooper & Dunham LLP, 1185 Avenue of the Americas, New York, NY, 10036, US

(73) Assignee: Katakura Industries Co., Ltd.

(21) Appl. No.: 10/659,005

(22) Filed: Sep. 9, 2003

Related U.S. Application Data
(63) Continuation of application No. PCT/JP02/04357, filed on May 1, 2002.

(30) Foreign Application Priority Data
Oct. 18, 2001 (JP) 2001-320263

(51) Int. Cl. F16K 31/02; F02B 43/00

(52) U.S. Cl. 123/529; 251/129.09

(57) ABSTRACT

In a gaseous fuel supply apparatus with a shut-off valve, the valve includes a valve housing provided in a gas flow unit for supplying gaseous fuel from a fuel tank to a combustion engine, a seal member surrounding a valve port between a first port connecting to the tank and a second port connecting the engine in the housing, a valve member movable between a closed position at which the valve member is in contact with the seal member to close the valve port and an open position at which the valve member separates from the seal member to open the valve port, and a drive unit for driving the movement of the valve member by electromagnetic force.

### CROSS-REFERENCE TO RELATED APPLICATIONS

This is a Continuation Application of PCT Application No. PCT/JP02/04357, filed May 1, 2002, which was not published under PCT Article 21(2) in English.

This application is based upon and claims the benefit of priority from the prior Japanese Patent Application No. 2001-320263, filed Oct. 18, 2001, the entire contents of which are incorporated herein by reference.

### BACKGROUND OF THE INVENTION

1. Field of the Invention

The present invention relates to a gaseous fuel supply apparatus with a shut-off valve.

2. Description of the Related Art

In recent years, from the viewpoint of environmental and energy resources problem, development of an automobile with an internal combustion engine using gaseous fuel instead of a diesel engine has been actively pursued. The automobile with the gaseous fuel engine has a plurality of gaseous fuel tanks in which gaseous fuel such as natural gas is stored under a high pressure. Gaseous fuel is fed from each of the gaseous fuel tanks to the gaseous fuel engine through a gaseous fuel supply apparatus. Each of the gaseous fuel supply apparatus has a gaseous fuel flow unit, for example, including a gas pipe extending from each of the gaseous fuel tanks toward the gaseous fuel engine. The plurality of gaseous fuel flow units extending from the plurality of gaseous fuel tanks are unified into one by an unification element such as a manifold, and one unified gaseous fuel flow unit reaches at the gaseous fuel engine.

Each of the gaseous fuel supply apparatus further has a shut-off valve provided in the gaseous fuel flow unit between the unification element and the gaseous fuel tank, and the shut-off valve selectively opens or shuts a flow of the gaseous fuel in the gaseous fuel flow unit. The conventional shut-off valve has a valve drive unit for driving a valve member by an electromagnetic force.

The conventional shut-off valve used in such a conventional gaseous fuel supply apparatus as described above is well known by Jpn. Pat. Appln. KOKAI Publication No. 10-141516. The shut-off valve disclosed in this publication comprises: a valve housing which includes a first connection port connected to a first part of a gaseous fuel flow unit, the first part being close to a gaseous fuel tank, a second connection port connected to a second part of the gaseous fuel flow unit, the second part being close to the gaseous fuel engine, and a valve chest provided between the first and second connection ports and having a valve port communicating the first and second connection ports with each other; a valve member which is provided in the valve housing and is movable between a closed position and an open position, at the closed position the valve member closing the valve port of the valve chest and at the open position the valve member separating from the valve port and opening the valve port of the valve chest; and a valve member drive unit which drives the valve member by an electromagnetic force.

In an inside surface of the valve chest of the valve housing, an area around the valve port is tapered to form a valve seat. A part of the valve member facing the valve seat is also tapered, and an O-ring is fit to a surface of the tapered part of the valve member.

In the conventional gaseous fuel supply apparatus, a gaseous fuel charge unit, for example, including a gas pipe, is branched from the unification element to charge gaseous fuel from an outer side into the gaseous fuel tank. A connection element for detachably connecting with an outer gaseous fuel source is provided on an extending end of the gaseous fuel charge unit. The gaseous fuel charge unit includes a switch valve at a position near to the connection element and a check valve at a position nearer to the unification element than the switch valve.

The gaseous fuel flow unit of the conventional gaseous fuel supply apparatus further has a by-pass unit with a check valve, which is for charging high-pressurized gaseous fuel into the gaseous fuel tank corresponding thereto. The by-pass unit connects a position between the unification element and the shut-off valve with a position between the shut-off valve and the gaseous fuel tank corresponding thereto in the gaseous fuel flow unit.

The gaseous fuel flow unit of the conventional gaseous fuel supply apparatus further has a check valve between the shut-off valve and the fuel tank sided bypass unit connection point. These by-pass unit and check valves are so structured that they prevent gaseous fuel from flowing through the shut-off valve while gaseous fuel is charged into the gaseous fuel tank from the outside.

In the conventional gaseous fuel supply apparatus as described above, the by-pass unit complicates the structure of the conventional gaseous fuel supply apparatus and increases the manufacturing cost of the conventional gaseous fuel supply apparatus.

If gaseous fuel charged from the outside to the gaseous fuel tank can be flown through the conventional shut-off valve for regulating a supply of gaseous fuel from the gaseous fuel tank to the gaseous fuel engine through the gaseous fuel flow unit, the conventional by-pass unit and the conventional check valves can be omitted so that the manufacturing cost of the conventional gaseous fuel supply apparatus can be decreased. However, if gaseous fuel charged from the outside into the gaseous fuel tank is flown through the conventional shut-off valve, the conventional shut-off valve tends to be failed.

The reason causing such a failure is as follows. The shut-off valve for the gaseous fuel flow unit drives the valve member relatively frequently by using electromagnetic force, and heat of high temperature generated by the electromagnetic force each time the valve member drive unit operates is transferred to the valve member. As a result, the heat of high temperature is also transferred to the O-ring on the valve member relatively frequently, and the O-ring is easily degraded by the heat. The degraded O-ring reduces the sealability of the shut-off valve.

Further, if the gaseous fuel charged from the outside into the gaseous fuel tank is flowed through the shut-off valve of the above described conventional gaseous fuel flow unit, the extremely highly pressurised gaseous fuel charged from the outside is expanded in an adiabatic condition and rapidly lowers the temperature thereof in the valve chest after the highly pressurised gaseous fuel passes through the valve port of the shut-off valve and flows into the valve chest. The gaseous fuel of such a low temperature is directly blown with high speed onto the O-ring on the valve member so that the O-ring on the valve member is rapidly chilled to lose the elasticity thereof. The elastically lowered O-ring tends to be broken into pieces and blown off from the valve member. And, this tendency becomes large with the progress of the degration of the O-ring by heat.

The present invention has been made under the above circumstances. It is an object of the present invention is to provide a gaseous fuel supply apparatus with a shut-off valve, which is simple in structure and is failed rarely.

### BRIEF SUMMARY OF THE INVENTION

In order to achieve the above described object, a gaseous fuel supply apparatus with a shut-off valve according to one aspect of the present invention, comprises:

a gaseous fuel flow unit which is communicated with a gaseous fuel tank and a gaseous fuel combustion engine and flows gaseous fuel between the gaseous fuel tank and the gaseous fuel combustion engine;

a shut-off valve which is provided in the gaseous fuel flow unit and selectively opens or closes a flow of the gaseous fuel in the gaseous fuel flow unit; and

a gaseous fuel charge unit which is provided in the gaseous fuel flow unit between the gaseous fuel combustion engine and the shut-off valve and is used to charge the gaseous fuel from an outside into the gaseous fuel flow unit.

And, the shut-off valve comprises:

a valve housing which includes a first connection port connected to a first part of the gaseous fuel flow unit, the first part being close to the gaseous fuel tank, a second connection port connected to a second part of the gaseous fuel flow unit, the second part being close to the gaseous fuel engine and the gaseous fuel charge unit, and a valve chest provided between the first connection port and the second connection port and having a valve port communicating the first and second connection ports with each other;

a seal member which surrounds the valve port on an inner surface of the valve chest of the valve housing;

a valve member which is provided in the valve housing and is movable between a closed position and an open position, at the closed position the valve member being in contact with the seal member and closing the valve port of the valve chest and at the open position the valve member separating from the seal member and opening the valve port of the valve chest; and

a valve member drive unit which drives the valve member by an electromagnetic force.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view of a gaseous fuel supply apparatus with a shut-off valve, according to an embodiment of the present invention;

FIG. 2 is an enlarged vertical sectional view of the shut-off valve of FIG. 1, with a valve member of the shut-off valve located at a closed position;

FIG. 3 is an enlarged exploded perspective view of the valve member and a plunger of a plunger-solenoid assembly, both being used in the shut-off valve of FIG. 2;

FIG. 4 is a vertical sectional view of the valve member of FIG. 3;

FIG. 5 is an enlarged vertical sectional view of one end portion of the plunger of FIG. 3;

FIG. 6 is a perspective view of an auxiliary seal member provided at the one end portion of the plunger of FIG. 5;

FIG. 7 is a vertical sectional view of a seal member supporting member which supports a seal member in a valve housing of FIG. 2;

FIG. 8 is a schematic vertical sectional view of the shut-off valve of FIG. 2, with the valve member of the shut-off valve being located at an open position; and

FIG. 9 is a schematic vertical sectional view of the shut-off valve of FIG. 2, with the valve member of the shut-off valve being in an initial state of moving from the closed position to the open position.

### DETAILED DESCRIPTION OF THE INVENTION

Hereinafter, a gaseous fuel supply apparatus with a shut-off valve, according to an embodiment of the present invention will be explained in detail with reference to the attached drawing.

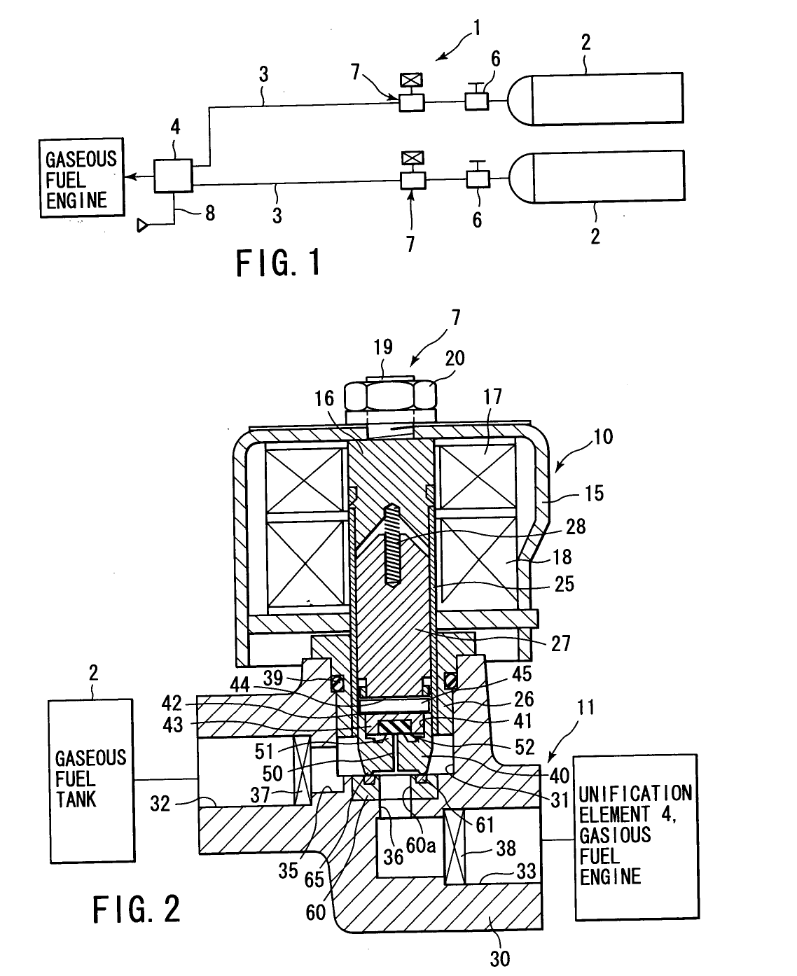

FIG. 1 shows a schematic view of the gaseous fuel supply apparatus with the shut-off valve, according to the embodiment of the present invention.

The gaseous fuel supply apparatus 1 is used for supplying gaseous fuel from a gaseous fuel tank 2 storing gaseous fuel such as natural gas, to an internal combustion engine using gaseous fuel. The gaseous fuel supply apparatus 1 can be installed in structures, vehicles and ships, together with the gaseous fuel tank 2 and the internal combustion engine using gaseous fuel. The vehicles include a bus, truck and passenger car.

In this embodiment, the gaseous fuel supply apparatus 1 has two fuel tanks 2, 2. Each of the two fuel tanks 2, 2 has one gaseous fuel inlet-outlet hole. A gaseous fuel flow unit 3 including a gas pipe is extended from the one gaseous fuel inlet-outlet hole. The extended ends of two gaseous fuel flow units 3 are unified into one unified gaseous fuel flow unit by an unification element 4 such as a manifold, and the one unified gaseous fuel flow unit is connected to the gaseous fuel internal combustion engine.

A normally opened fuel tank open/close valve 6 is provided at a position near to the one gaseous fuel inlet-outlet hole on each of the gaseous fuel flow units 3, and further a shut-off valve 7 driven electromagnetically is provided at a position opposite to the one inlet-outlet hole with respect to the open/close valve 6 on each of the gaseous fuel flow units 3. The electromagnetically driven shut-off valve 7 is so structured that it selectively opens or closes the flow of gaseous fuel in the gaseous fuel flow units 3.

A gaseous fuel charge unit 8, for example including a gas pipe, is also connected to the unification element 4, and the charge unit 8 is used for charging high pressurized gaseous fuel from an outer gaseous fuel source (not shown) into the gaseous fuel tanks 2. A connection element (not shown) for detachably connecting with the outer gaseous fuel source (not shown) is provided on the extended end of the charge unit 8. The charge unit 8 includes a switch valve (not shown) at a position near to the connection element and a check valve (not shown) at a position nearer to the unification element than the switch valve.

Further, a pressure gauge (not shown) is provided on the unification element 4, and the pressure gauge is used for measuring the pressure of gaseous fuel passing therethrough.

Next, the configuration of the electromagnetically driven shut-off valve 7 will be explained in detail with reference to FIGS. 2 to 7.

Referring to FIG. 2, the shut-off valve 7 comprises a valve member drive unit 10 and a valve structure 11.

The drive unit 10 includes an outer housing 15 and a plunger-solenoid assembly housed in the outer housing 15. The plunger-solenoid assembly includes a rod-shaped core 16 and two types of solenoid coils 17, 18. These coils 17, 18 are wound independently each other around the outer circumferential surface of the rod-shaped core 16 at two positions separated from each other along the longitudinal direction of the core 16. A male screw is formed on the outer circumferential surface of one end portion 19 of the core 16. The one end portion 19 of the core 16 is inserted into a through-hole formed in the outer housing 15, directing from the inside space to the outside space of the outer housing 15. A nut 20 is fixed to the outer projecting one end portion of the core 16. With this structure, the core 16 with the solenoid coils 17, 18 is located at a predetermined position in the inside space of the outer housing 15.

The first solenoid coil 17 located near to the one end portion 19 is configured to have a larger resistance than that of the second solenoid coil 18 located far from the one end portion 19.

One end portion of a cylindrical movement guide member 15 is fixed to the outer circumferential surface of the other end portion of the core 16 by well known fixing means, for example, such as welding, so that the guide member 15 is coaxially arranged with the core 16. A connection member 26 for connecting with the valve structure 11 is fixed to the outer circumferential surface of the other end portion of the guide member 25. In this embodiment, a male screw is formed on the outer circumferential surface of the connection member 26.

A columnar-shaped plunger 27 is arrange in the inside space of the guide member 25, and the plunger 27 is slidable in the longitudinal direction of the guide member 25. A tapered concave is formed in the end of the other end portion of the core 16, and the end of the one end portion of the plunger 27 facing the end of the other end portion of the core 16 is tapered to correspond to the above-mentioned tapered concave. An urging element 28 is provided between the center of the concave on the end of the other end portion of the core 16 and the center of the end of the tapered one end portion of the plunger 27. In this embodiment, the urging element 28 has a compression coil spring.

The valve structure 11 includes a valve housing 30. The valve housing 30 is in contact with and fixed to a good thermal conductive member in an object in which the gaseous fuel supply apparatus 1 is installed. If the apparatus is installed in a vehicle, the good thermal conductive member is, for example, a chassis.

The valve housing 30 includes a valve chest 31, a first connection port 32 connected to a first part of the gaseous fuel flow unit 3, the first part being close to the gaseous fuel tank 2, and a second connection port 33 connected to a second part of the gaseous fuel flow unit 3, the second part being close to the internal combustion engine and unification element 4 (i.e., the gaseous fuel charge unit 8). The valve chest 31 is provided between the first connection port 32 and the second connection port 33, and is communicated with the first connection port 32 through a communicating port 35. The valve chest 31 is further communicated with the second communicating port 33 through a valve port 36. Filters 37 and 38 are fixed in the first connection port 32 and second connection port 33, and these filters 37 and 38 catch foreign matters included in the gaseous fuel passing through the first and second connection ports 32 and 33. These filters 37 and 38 may be detachably fixed in the first and second connection ports 32 and 33.

A valve member drive unit connection opening is formed at a position facing the valve port 36 in the inside surface of the valve chest 31. The connection member 26 on the other end portion of the cylindrical movement guide member 25 of the valve drive unit 10 is fixed to the valve member drive unit connection opening, with a seal element 39 such as an O-ring.

A valve member 40 is provided between the valve port 36 and the other end portion of the plunger 27 of the valve member drive unit 10 in the valve chest 31 of the valve housing 30.

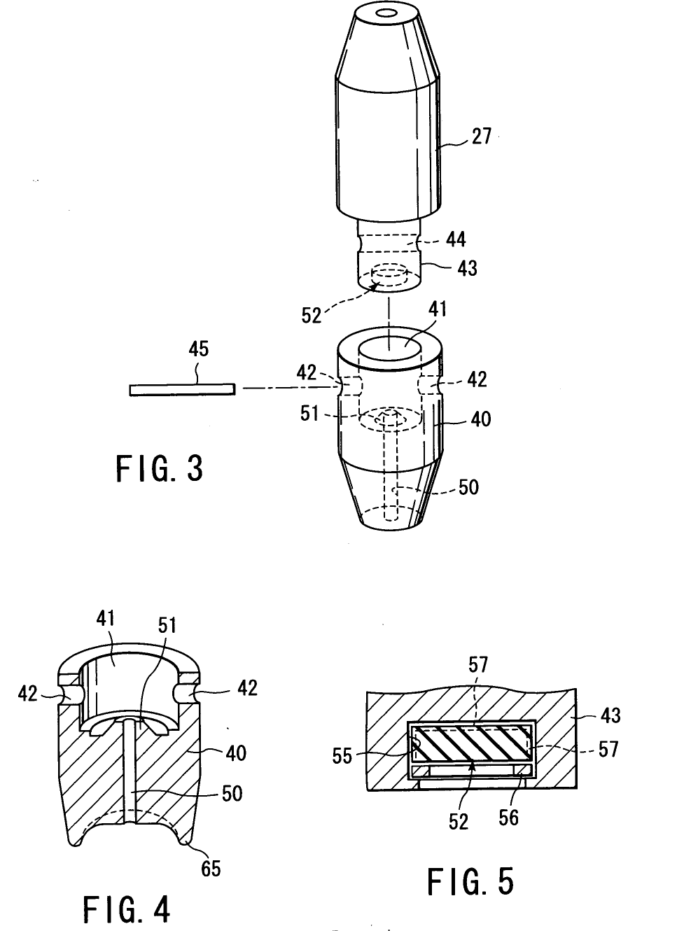

As particularly shown in FIG. 3 in the enlarged fashion, a cylindrical blind hole 41 is formed in one end (the plunger facing end) of the valve member 40 which faces the other end portion of the plunger 27, and the cylindrical blind hole 41 is arranged coaxially to the longitudinal center line of the plunger 27. A pair of connection holes 42 are also formed in the valve member 40, and the connection holes 42 are arranged on a line orthogonally extending to the longitudinal center line of the plunger 27. The connection holes 42 penetrate the cylindrical blind hole 41 in the diametrical direction of the plunger 27.

The other end portion of the plunger 27 is made as a small-diameter column 43, and can be inserted into the cylindrical blind hole 41 of the valve member 40. The small-diameter column 43 of the plunger 27 is slidable in the cylindrical blind hole 41 of the valve member 40 along the longitudinal direction of the plunger 27. A connection hole 44 is formed in the small-diameter column 43, and is extending in the diametrical direction of the plunger 27. The diameter of the connection hole 44 in the small-diameter column 43 of the plunger 27 is smaller than the diameter of each of the connection holes 42 of the valve member 40.

Before the valve member drive unit 10 is connected with the valve housing 30 as described above, the cylindrical blind hole 41 of the valve 40 is fitted on the small-diameter column 43 of the other end portion of the plunger 27, and a connecting rod 45 is inserted into the connection hole 44 in the small-diameter column 43 of the plunger 27 through the connection holes 42 of the valve member 40. As a result of this, the valve member 40 is connected to the other end portion of the plunger 27 by the connecting rod 45, and the valve member 40, together with the other end portion of the plunger 27, is movable. Further, the above-mentioned difference between the diameter of the connection hole 44 of the small-diameter column 43 of the plunger 27 and the diameter of each of the connection holes 42 of the valve member 40 causes the valve member 40 to be movable relative to the plunger 27 on the outer circumferential surface of the small-diameter column 43 of the plunger 27 along the longitudinal direction of the plunger 27 by the above-mentioned difference.

A communication port 50 is further formed in the valve member 40. One end of the communication port 50 opens at the other end of the valve member 40, and the other end of the communication port 50 opens at the one end of the valve member 40, the other end facing the valve port 36 of the valve chest 31 of the valve housing 30 (that is, the valve port facing end) and the one end facing the plunger 27 (that is, the plunger facing end). More precisely, both ends of the communication port 50 open at a center of the bottom surface of the blind hole 41 on the one end (the plunger facing end) and at a center of the other end (the valve port facing end).

As particularly shown in FIG. 4 in the enlarged fashion, a circular projection 51 is provided around the opening of the communication port 50 at the bottom surface of the blind hole 41, and the circular projection 51 swells up like a tapered shape around the above-mentioned opening.

As shown in FIGS. 2 and 3, an auxiliary seal member 52 is provided at the center portion of the end of the small-diameter column 43 of the plunger 27. The auxiliary seal member 52 is made of synthetic rubber, for example.

As particularly shown in FIG. 5 in the enlarged fashion, au auxiliary seal member storing concave 55 is formed in the center portion of the end of the small-diameter column 43 of the plunger 27. A diametrical size of the inner periphery of the storing concave 55 in the diametrical direction of the plunger 27 is larger than that of the opening of the storing concave 55 at the end of the plunger 27 in the diametrical direction. The auxiliary seal member 52 is stored in the storing concave 55, and a circular stop washer 56 having the outer diameter larger than the diametrical size of the above-mentioned opening is also stored in the storing concave 55 between the above-mentioned opening and the auxiliary seal member 52. The circular stop washer 56 prevents the auxiliary seal member 52 from escaping off from the storing concave 55 through the opening.

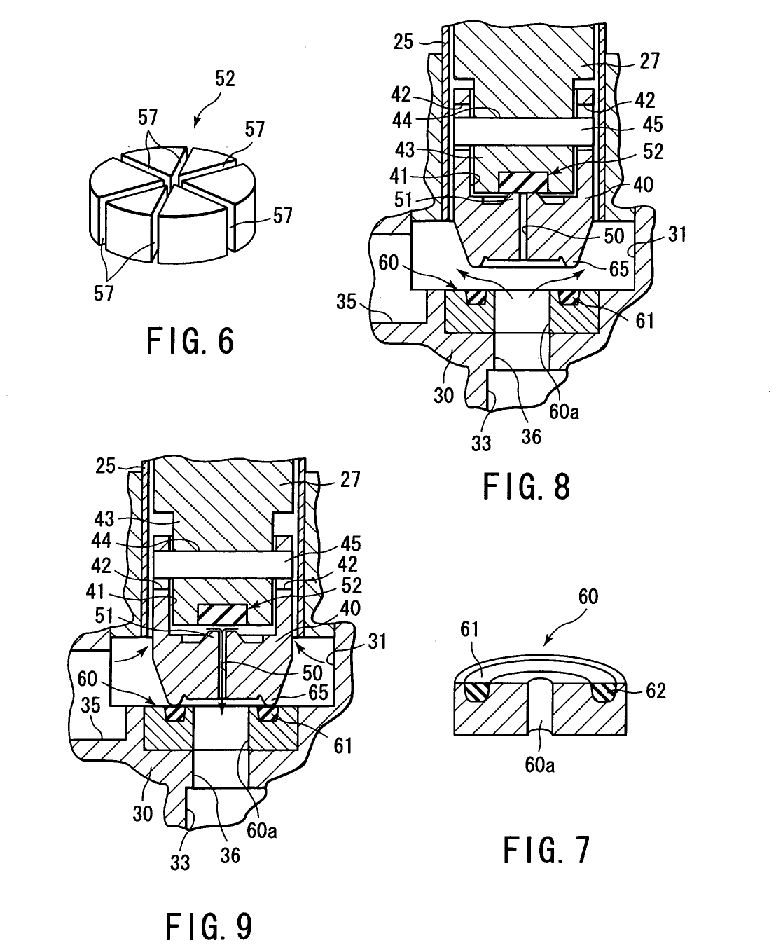

As particularly shown in FIG. 6, a plurality of radially extending grooves 57 is formed in a region of the outside surface of the auxiliary seal member 52, the region facing the inside surface of the storing concave 55. The plurality of grooves 57 configure a communicating structure for communicating the clearance between the inside surface of the storing concave 55 and the inside surface facing region of the outside surface of the auxiliary seal member 52, with the clearance between the end of the other end portion of the plunger 27 (the end of the small-diameter column 43) and the plunger facing end of the valve member 40 (the bottom surface of the blind hole 41), through the opening of the storing concave 55.

Now, referring back to FIG. 2, a circular seal member 61 is fixed to the circular part surrounding the valve port 36 on the inside surface of the valve chest 31 in the valve housing 30. The seal member 61 is made of synthetic rubber, for example.

Explaining in more detail with reference to FIG. 7 in addition to FIG. 2, in this embodiment, a circular seal member support block 60 is fixed to the circular part surrounding the valve port 36 on the inside surface of the valve chest 31 in the valve housing 30. The circular support block 60 is formed independently of the valve housing 30. The circular support block 60 may be detachably fixed to the circular part on the inside surface of the valve chest 31. A circular groove 62 is formed in a region of the outside surface of the circular support block 60, the region facing the valve member 40, and the circular groove 62 surrounds the valve port 36. The circular seal member 61 is provided and fixed in the circular groove 62. A center hole 60a of the circular support block 60 allows the communication between the valve chest 31 and second connection port 33 through the valve port 36.

As shown in FIGS. 2 and 4, a circular projection 65, projecting toward the circular seal member 61 around the valve port 36, is formed at the other end (the valve port facing end) of the valve member 40, the other end facing the valve port 36 of the valve chest 31.

In the shut-off valve 7 structured as described above, the plunger 27 with the valve member 40 is normally urged, by the urging element 28, toward the valve port 36 of the valve chest 31 in the valve housing 30. Therefore, while electric current is not applied to the two solenoid coils 17 and 18 of the valve member drive unit 10, the circular projection 65 at the other end (the valve port facing end) of the valve member 40 is pressed on the circular seal member 61 around the valve port 36 by the urging force of the urging element 28 applied to the valve member 40 through the plunger 27, as shown in FIG. 2. Further, the auxiliary seal member 52 at the end of the other end portion of the plunger 27 (the end of the small-diameter column 43) is pressed on the projected end of the tapered projection 51 at the plunger facing end of the valve member 40 (the bottom of the blind hole 41) while the valve member 40 is arranged in the sealing position on the seal member 61.

In this state, the shut-off valve 7 completely shuts off the communication through the valve chest 31 and valve port 36 between the first connection port 32 and second connection port 33 (i.e., between the gaseous fuel tank 2 and the gaseous fuel engine).

Now, the operation of the gaseous fuel supply apparatus with the shut-off valve, according to the embodiment of the present invention and configured as described above, will be described.

When charging gaseous fuel from the external gaseous fuel source (not shown) into one of the two gaseous fuel tanks 2, the external gaseous fuel source (not shown) is connected with the connection element (not shown) at the extended end of the gaseous fuel charge unit 8 while electric current is not applied the two types of solenoid coils 17 and 18 of the shut-off valve 7 of each of the two gaseous fuel flow unit 3 and the shut-off valve 7 makes the valve member 40 arrange at the above described sealing position only by the urging force of the urging element 28.

Then, the above described switch valve (not shown) in the gaseous fuel charge unit 8, and gaseous fuel is charged from the external gaseous fuel source (not shown) through the gaseous fuel charge unit 8 and unification element 4 into the two gaseous fuel tanks 2. The pressure of the charged gaseous fuel is very larger than that of gaseous fuel in the two gaseous fuel tanks 2. Therefore, the high pressurized gaseous fuel flowing from the external gaseous fuel source (not shown) into the second connection port 33 of the shut-off valve 7, pushes the valve member 40 together with the plunger 27 toward the core 16 against the pressure of the low pressurized gaseous fuel in the valve chest 31 communicating with the gaseous fuel tank 2 and the urging force of the urging element 28 of the valve member drive unit 10.

As a result, as shown in FIG. 8, the valve member 40 separates from the seal member 61 around the valve port 36 in the valve chest 31, and the high pressurized gaseous fuel flowing from the valve port 36 into the valve chest 31 is charged into the gaseous fuel tank 2 through the first connection port 35 and the remaining part of the gaseous fuel flow unit 3. During this charging, the high pressurized gaseous fuel flowing through the shut-off valve 7 passes through the filters 38 and 37 provided in the second connection port 33 and first connection port 32. If the high pressurized gaseous fuel contains foreign materials, the foreign materials are caught by the filters 38 and 27, and the foreign materials do not flow into the gaseous fuel tank 2.

The above-mentioned high pressurized gaseous fuel expands in the adiabatic condition and rapidly lowers the temperature thereof in the valve chest 31 just after the high pressurized gaseous fuel passes through the valve port 36 of the valve housing 30. However, the gaseous fuel of low temperature just after passing through the valve port 36 is not directly blown on the seal member 61 around the valve port 36. Therefore, the seal member 61 do not lose its elasticity greatly by the gaseous fuel of low temperature, and the seal member 61 is not drawn away from the groove 62 of the seal member support block 60 by the flow of the high pressurized gaseous fuel passing through the valve port 36 at high speed.

Further, the seal member support block 60 is made of material with a high thermal conductivity and high resistant to a change in temperature, the low temperature transferred from the high pressurized gaseous fuel of low temperature in the valve chest 31 to the seal member support block 60 can be rapidly diffused to the valve member housing 30 and the above-mentioned object with which the valve member housing 30 is in contact and in which the gaseous fuel supply apparatus 1 is installed. This causes the degree of loose of elasticity of the seal member 61 to be further lowered.

This filing is stopped when the above described pressure gauge (not shown) provided to the unification element 4 reaches a predetermined value. At this time, the above described switch valve (not shown) of the gaseous fuel charge unit 8 is closed, and then the outer gaseous fuel source (not shown) is separated from the connection element (not shown) at the extended end of the gaseous fuel charge unit 8.

After the charging of the gaseous fuel is stopped as described above and the gaseous fuel does not flow through the valve port 36 of the valve housing 30, the valve member 40 together with plunger 27 is pushed back toward the seal member 61 around the valve port 36 in the valve chest 31 in the valve housing 30 by the urging force of the urging element 28 of the valve member drive unit 10. And, as shown in FIG. 2, the circular projection 65 at the end (the valve port facing end) of the other end portion of the valve member 40 is pressed on the circular seal member 61 around the valve port 36, and the auxiliary seal member 52 at the end of the other end portion of the plunger 27 (the end of the small-diameter column 43) is pressed on the projected end of the tapered projection 51 of the plunger facing end (the bottom surface of the blind hole 41) of the valve member 40.

In this state, the shut-off valve 7 completely shuts off the communication through the valve port 36 and valve chest 31 between the first connection port 32 and the second connection port 33 (i.e., between the gaseous fuel tank 2 and the gaseous fuel engine).

Further, the valve member 40 facing the valve port 36 directly is strongly urges to the closed position shown in FIG. 2, by the pressure difference between the gaseous fuel in the valve chest 31 communicating through the first connection port 32 with the gaseous fuel tank 2 in which the high pressurized gaseous fuel is charged, and the gaseous fuel in the second connection port 33 communicating with the gaseous fuel engine that is shut off the communication with the gaseous fuel tank 2 by the shut-off valve 7.

In this state, the urging force coursed by the above described pressure difference is also applied to the plunger 27 which faces the valve port 36 indirectly through the communication hole 50 of the valve member 40. However, since the cross sectional area of the communication hole 50 is very small relative to that of the valve port 36, the urging force applied on the plunger 27 by the above described pressure difference is very small relative to the urging force applied on the valve member 40 by the above described pressure difference.

To drive the gaseous fuel engine by the gaseous fuel supplied from one of the gaseous fuel tanks 2, at first a current with predetermined voltage is applied to the second solenoid coil 18 of low resistance of the valve member drive unit 10 in the shut-off valve 7 of each of the two gaseous fuel flow units 3 to generate a relatively large electromagnetic force.

The valve member 40 is freely movable relative to the plunger 27 by the above-mentioned difference (predetermine distance) between the diameter of each of the connection holes 42 of the valve member 40 and the diameter of the connection hole 44 of the small-diameter column 43 of the plunger 27. Therefore, when the above-mentioned relatively large electromagnetic force is applied to the plunger 27, the plunger 27 is easily moved by the above-mentioned predetermined distance in a direction in which the plunger 27 moves away from the valve port 36, against the urging force of the urging element 28 and the small urging force caused by the above described pressure difference, while the valve member 40 is held at the closed position shown in FIG. 2 by the relatively large urging force caused by the above described pressure difference.

As a result, as shown in FIG. 9, the auxiliary seal member 52 at the end of the small-diameter column 43 of the plunger 27 is separated from the end of the tapered projection 51 at the bottom surface of the blind hole 41 in the plunger facing end of the outside surface of the valve member 40.

The clearance between the end of the small-diameter column 43 of the plunger 27 and the bottom surface of the blind hole 41 in the plunger facing end of the outside surface of the valve member 40, is communicated with the internal space in the valve chest 31 through the clearance between the outer circumferential surface of the column 43 and the inner circumferential surface of the blind hole 41 of the valve member 40, the clearance between the connection rod 45 and each of the two connection ports 42 of the valve member 40, and the clearance between the inner circumferential surface of the cylindrical movement guide member 25 and the outer circumferential surface of the valve member 40. Therefore, a part of the high pressurized gaseous fuel in the valve chest 31 flows out from these clearances to the valve port 36 and the second connection port 33 through the communication hole 50 of the valve member 40. And, the pressure difference between the gaseous fuel in the valve chest 31 and the gaseous fuel in the second connection port 33 is lowered, and the urging force caused by the pressure difference and urging the valve 40 toward the closed position is lowered.

That is, the unification of the auxiliary seal member 52 at the end of the small-diameter column 43 of the plunger 27 and the communication hole 50 of the valve member 40 functions selectively to lower the pressure difference.

At a moment when the auxiliary seal member 52 at the end of the small-diameter column 43 of the plunger 27 separates from the end of the tapered projection 51 at the bottom surface of the blind hole 41 in the plunger facing end of the outside surface of the valve member 40, the high pressurized gaseous fuel rapidly flows from the above-mentioned clearance into the communication hole 50 of the valve member 40 so that the auxiliary seal member 52 is strongly drawn toward the communication hole 50.

The auxiliary seal member 52 may be attached to the auxiliary seal member storing concave 55 in the end of the small-diameter column 43 of the plunger 27 by forcibly fitting the auxiliary seal member 52 in the storing concave 55. However, in this case, a clearance is formed between the bottom surface of the storing concave 55 and the bottom surface facing end of the outer surface of the auxiliary seal member 52. while the valve member 40 and the plunger 27 are located in the closed position, the high pressurized gaseous fuel in the valve chest 31 is flown into and stored in this clearance after the high pressurized gaseous fuel passes through the clearance between the end of the small-diameter column 43 of the plunger 27 and the bottom surface of the blind hole 41 in the plunger facing end of the outer surface of the valve member 40 and penetrates the auxiliary seal member 52. The high pressurized gaseous fuel stored in the clearance on the bottom surface of the storing concave 55 serves to push out the auxiliary seal member 52 from the storing concave 55 when the auxiliary seal member 52 separates from the communication hole 50 and is strongly drawn toward the communication hole 50 as described above. If this phenomenon is repeated, the auxiliary seal member 52 may drop off from the end of the small-diameter column 43 of the plunger 27.

However, in this embodiment, the communication structure configured by the plurality of grooves 57 formed in the inside surface facing region of the outside surface of the auxiliary sealing member 52 (refer to FIGS. 5 and 6) always surely communicates the clearance between the inside surface of the storing concave 55 and the inside surface facing region of the outside surface of the auxiliary sealing member 52 with the valve chest 31. With this structure, although the high pressurized gaseous fuel from the valve chest 31 is stored in the clearance while the valve member 40 and the plunger 27 are located in the closed position, the high pressurized gaseous fuel stored in the clearance will not serve to push out the auxiliary sealing member 52 from the storing concave 55 while the auxiliary seal member 52 separates from the communication hole 50 and is strongly drawn toward the communication hole 50 as described above.

After the auxiliary seal member 52 on the small-diameter column 43 of the plunger 27 is separated from the communication hole 50 and the above described pressure difference strongly urging the valve member 40 toward the closed position is lowered as described above, the above described predetermined free movement of the plunger 27 relative to the valve member 40 is completed. Then, the plunger 27 further moves with carrying the valve member 40, and can separates the valve member 40 easily from the closed position shown in FIG. 9.

After the valve member 40 is separated from the closed position shown in FIG. 9, electric current with the predetermined voltage is further applied to the first solenoid coil 17 of high resistance of the valve member drive unit 10. And, the drive unit 10 can hold the plunger 27 together with the valve member 40 at the open position against the urging force of the urging element 28, by the electromagnetic force generated in the first and second solenoid coils 17 and 18. While the plunger 27 together with the valve member 40 is held at the open position as described above, the valve member 40 can be movable relative to the small-diameter column 43 of the other end portion of the plunger 27 in the above described predetermined distance. However, the valve member 40 is not arranged in the closed position while the valve member 40 moves in the above described predetermined distance.

The valve member drive unit 10 selectively uses the first or second solenoid coil 17 or 18 to move the valve member 40 from the closed position to the open position and then hold the valve member 40 in the open position. This makes the electric consumption which is need to operate the shut-off valve 7 according to the one embodiment of the present invention lower. Therefore, the plunger 27 and the valve member 40 are not heated heavily by the electromagnetic force generated for the above described operation, and the auxiliary seal member 52 provided on the end of the other end portion of the small-diameter column 43 of the plunger 27 is not influenced severely by the heat transferred from the plunger 27. Further, the plurality of grooves 57 of the communication structure on the inside surface facing region of the outer side surface of the plunger 27 lowers the influence of the transferred heat from the plunger 27 to the auxiliary seal member 52.

More further, the valve member 40 held in the open position is not in contact with the seal member 61 provided on the inside surface of the valve chest 31 and surrounding the valve port 36. This causes the heat generated in the valve member drive unit 10 for moving the valve member 40 from the closed position to the open position and then holding the valve member 40 in the open position, not to be transferred to the seal member 61 through the plunger 27 and the valve member 40. And, the seal member 61 is not influenced by the heat.

Even if the heat is transferred to the valve housing 30 of the valve structure 11 from the valve member drive unit 10 through the connection member 26, the transferred heat is rapidly diffused to the above-mentioned object with which the valve housing 30 is in contact and to which the gaseous fuel supply apparatus 1 is provided. And, the seal member 61 is not degraded.

Further, since the seal member support block 60 holding the seal member 61 is formed independently of the valve housing 30, it is possible to perform a process for making the seal member support block 60 hold the seal member 61 sufficiently and independently of the valve housing 30. This process includes roughing (e.g., shot blasting) the inside surface of the groove 62 (refer to FIG. 7) to increase the strength of holding the seal member 61 in the circular groove 62, applying adhesive in the groove 62, injecting material of the seal member 61 into the groove 62 to hold the seal member 61 into the groove 62 and vulcanizing the injected material in the groove 62 to fix the seal member 61 in the circular groove 62. It is important not to make a clearance between the inside surface of the groove 62, the adhesive applied to the inside surface, and the seal member 61 injected into the inside surface, by the application of the adhesive, injection of seal member 61 and vulcanizing of the injected seal member 61.

With this process, the holding strength of the seal member 61 in the seal member support block 60 can be extremely increased. Further, when replacing the seal member 61, the seal member support block 60 holding the seal member 61 to be replaced can be removed from a predetermined region surrounding the valve port 36 in the inside surface of the valve chest 31 of the valve housing 30, and then a new seal member support block 60 holding a new seal member 61 can be fixed to the predetermined region. Therefore, it is obvious that this detachably fixed seal member support block 60 makes the replacement of the seal member 61 being much faster and more secure, comparing with the case of fixing the seal member 61 directly to the predetermined region.

To stop supplying gaseous fuel from the two gaseous fuel tanks 2 to the gaseous fuel engine, apply of the electric current to the two solenoid coils 17 and 18 of valve member drive unit 10 is stopped.

As a result, the valve member 40 together with the plunger 27 is pushed back toward the seal member 61 around the valve port 36 in the valve chest 31 of the valve housing 30, by the urging force of the urging element 28 of the valve member drive unit 10. And, as shown in FIG. 2, the circular projection 65 at the other end (the valve port facing end) of the valve member 40 is pressed on the circular seal member 61 around the valve port 36, and the auxiliary seal member 52 at the end of the other end portion of the plunger 27 (the end of the small-diameter column 43) is pressed on the projected end of the tapered projection 51 in the plunger facing end of the valve member 40 (the bottom surface of the blind hole 41).

In this state, the shut-off valve 7 completely shuts off the communication between the first connection port 32 and the second connection port 33 (i.e., between the gaseous fuel tank 2 and the gaseous fuel engine) through the valve port 36 and valve chest 31.

Further, the valve member 40 is strongly urged to the closed position shown in FIG. 2, by the pressure difference between the gaseous fuel in the valve chest 31 communicating with the gaseous fuel tank 2 charged with the high pressurized gaseous fuel through the first connection port 32, and the gaseous fuel in the second connection port 33 communicating with the gaseous fuel engine that is interrupted the communication with the gaseous fuel tank 2 by the shut-off valve 7.

In one embodiment described above with reference to FIG. 2, gaseous fuel is supplied from the two gaseous fuel tanks 2, 2 to one gaseous fuel engine, or gaseous fuel is charged from an external gaseous fuel source into two gaseous fuel tanks 2, 2. However, according to the aspect of the present invention, the gaseous fuel supply apparatus according to the present invention can be configured to supply gaseous fuel from one gaseous fuel tank to one or plural gaseous engines, and to supply gaseous fuel from two or more gaseous fuel tanks to one or multiple gaseous fuel engines.

Further, in the valve member drive unit 10, if the material of auxiliary seal member can be held in the storing concave 55 at the end of the small-diameter column 43 of the plunger 27 without no clearance therebetween, such a no clearance held auxiliary seal member as described above can be used in place of the combination of the stop washer 56 and the auxiliary seal member 52 on the outside surface of which the plural grooves 57 are formed as shown in FIGS. 5 and 6. The no clearance held auxiliary seal member can be obtained by the same process as the above described process through which the seal member 61 is held in the circular groove 62 of the seal member holding block 60. That is, the process includes roughing (e.g., shot blasting) the inside surface of the storing concave 55 to increase the strength of holding the no clearance held auxiliary seal member in the storing concave 55, applying adhesive in the storing concave 55, injecting material of the auxiliary seal member into the storing concave 55 and vulcanizing the injected material in the storing concave 55 to fix the auxiliary seal member in the storing concave 55. It is important not to make a clearance between the inside surface of the storing concave 55, the adhesive applied to the inside surface, and the auxiliary seal member injected into the inside surface, by the application of the adhesive, injection of auxiliary seal member and vulcanizing of the injected auxiliary seal member.

Further, if the positions of the two solenoid coils 17 and 18 in the valve member drive unit 10 are changed to each other, the valve member drive unit in which the positions of the two solenoid coils 17 and 18 are changed to each other as described above can perform the same operation as the valve member drive unit 10 in which the two solenoid coils 17 and 18 are positioned as shown in FIG. 2.

More further, the circular seal member 61 may be directly fixed to the circular part surrounding the valve port 36 on the inside surface of the valve chest 31 in the valve housing 30, without using the circular seal member support block 60 formed independently of the valve housing 30. In this case, a circular groove is formed in the circular part surrounding the valve port 36 on the inside surface of the valve chest 31 in the valve housing 30, and the circular seal member 61 is provided and fixed in the circular groove 62. The process for this provision and fixation may be the same as that for providing and fixing the material of the seal member 61 in the circular groove 62 formed on the above described seal member support block 60.

More further, the gaseous fuel supply apparatus 1 according to one embodiment of the present invention and described above may be used to supply gaseous fuel to any kinds of gaseous fuel combustion engine other than the gaseous fuel internal combustion engine, including such as a gaseous fuel external combustion engine.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A gaseous fuel supply apparatus with a shut-off valve, which supplies gaseous fuel from a gaseous fuel tank storing gaseous fuel to a gaseous fuel combustion engine using gaseous fuel, comprising:
a gaseous fuel flow unit which is communicated with the gaseous fuel tank and the gaseous fuel combustion engine and flows gaseous fuel between the gaseous fuel tank and the gaseous fuel combustion engine;
a shut-off valve which is provided in the gaseous fuel flow unit and selectively opens or closes a flow of the gaseous fuel in the gaseous fuel flow unit; and
a gaseous fuel charge unit which is provided in the gaseous fuel flow unit between the gaseous fuel combustion engine and the shut-off valve and is used to charge the gaseous fuel from an outside into the gaseous fuel flow unit,
the shut-off valve comprising:
a valve housing which includes a first connection port connected to a first part of the gaseous fuel flow unit, the first part being close to the gaseous fuel tank, a second connection port connected to a second part of the gaseous fuel flow unit, the second part being close to the gaseous fuel engine and the gaseous fuel charge unit, and a valve chest provided between the first connection port and the second connection port and having a valve port communicating the first and second connection ports with each other;
a seal member which surrounds the valve port on an inner surface of the valve chest of the valve housing;
a valve member which is provided in the valve housing and is movable between a closed position and an open position, at the closed position the valve member being in contact with the seal member and closing the valve port of the valve chest and at the open position the valve member separating from the seal member and opening the valve port of the valve chest; and
a valve member drive unit which drives the valve member by an electromagnetic force.

2. A gaseous fuel supply apparatus according to claim 1, wherein a circular projection is provided on a part of the valve member of the shut-off valve, the part contacting and separating from the seal member, and the circular projection surrounds the valve port of the valve chest in the valve housing while the circular projection is in contact with the seal member.

3. A gaseous fuel supply apparatus according to claim 1, wherein the shut-off valve further comprises a circular seal member support block which is formed independently of the valve housing, surrounds the valve port on the inside surface of the valve chest in the valve housing, and supports the seal member.

4. A gaseous fuel supply apparatus according to claim 3, wherein the seal member support block has a circular groove in which the seal member is provided.

5. A gaseous fuel supply apparatus according to claim 1, wherein a filter is provided in at least one of the first connection port and second connection ports in the valve housing, and catches foreign materials contained in the gaseous fuel passing through the ports.

6. A gaseous fuel supply apparatus according to claim 1, wherein
the valve drive unit includes a plunger-solenoid assembly, and the valve member is connected to one end portion of the plunger of the assembly to be movable with respect to the plunger in a predetermined distance along the moving direction of the plunger;
only the plunger moves without separating the valve member from the seal member of the valve chest in the valve housing, in an initial step before one end portion of the plunger moves in the predetermined distance with respect to the valve member while the plunger moves in a direction being away from the seal member of the valve chest; and
the plunger moves together with the valve member and separates the valve member from the seal member of the valve chest in the valve housing, in a step after the one end portion of the plunger moves in the predetermined distance with respect to the valve member in the direction being away from the seal member.

7. A gaseous fuel supply apparatus according to claim 6, wherein
the plunger-solenoid assembly includes two types of solenoid coils, and an urging element which urges the plunger toward the seal member of the valve chest in the valve housing and presses the valve member on the seal member while the two solenoid coils are not applied with electric current;
one of the two solenoid coils is applied with electric current to drive the valve member from the closed position toward the open position, so that a force which is larger than a total of a force generated by a pressure difference between the gaseous fuel in the first connection port and that in the second connection port in the valve housing and holds the valve member in the closed position and an urging force of the urging element applied on the valve member, is applied on the plunger to drive the valve member from the closed position to the open position; and
both of the solenoid coils are applied with electric current while the valve member is arranged in the open position, so that a force larger than the urging force applied on the valve member by the urging element is applied on the plunger to hold the valve member in the open position against the urging force.

8. A gaseous fuel supply apparatus according to claim 6, wherein
a communication hole is provided in the valve member, the communication hole having both ends one of which is opened at one part of the outside surface of the valve member and another of which is opened at another part of the outside surface of the valve member, the one part facing the valve port of the valve chest in the valve housing while the valve member is arranged at the closed position, and the another part facing the end of the one end portion of the plunger;
an auxiliary seal member is provided at the end of the one end portion of the plunger;
the auxiliary seal member closes the opening of the communication hole at the plunger facing part of the valve member while the two types of solenoid coils are not excited and the plunger holds the valve member at the closed position by the urging force of the urging member, and separates from the opening of the communication hole at the plunger facing part of the valve member when the plunger starts to move with respect to the valve member in the initial step while the valve member moves from the closed position to the open position;
a concave is formed in the end of the one end portion of the plunger, to hold the auxiliary seal member, and
a communication structure is provided in at least one of the inside surface of the concave and a region of the outside surface of the auxiliary seal member, the region facing the inside surface of the concave, and the communication structure communicates a clearance between the inside surface of the concave and the inside surface facing region of the outside surface of the auxiliary seal member, to a clearance between the end of the one end portion of the plunger and the plunger facing part of the valve member; and
the clearance between the end of the one end of the plunger and the plunger facing part of the valve member communicates with one side of the valve port in the valve chest in the valve housing, the one side commutating with the first commutation port.

9. A gaseous fuel supply apparatus according to claim 8, wherein the communication structure is at least one groove formed in the inside surface facing region of the outside surface of the auxiliary sealing member.

10. A gaseous fuel supply apparatus according to claim 8, wherein
the plunger facing part of the valve member has a circular projection surrounding the opening of the communication port in the plunger facing part and projecting toward the end of the one end portion of the plunger; and
the projected end of the circular projection on the plunger facing part of the valve member is in contact with the auxiliary seal member while the auxiliary seal member at the end of the one end portion of the plunger closes the opening of the communication hole at the plunger facing part of the valve member.
